(19) United States
(12) Patent Application Publication
(10) Pub. No.: US 2021/0081866 A1
(43) Pub. Date: Mar. 18, 2021

(54) PARKING LOT EVALUATION APPARATUS

(71) Applicant: HONDA MOTOR CO., LTD., Tokyo (JP)

(72) Inventors: Koki FUJISAWA, Tokyo (JP); Takamichi SHIMADA, Tokyo (JP)

(21) Appl. No.: 17/018,725

(22) Filed: Sep. 11, 2020

(30) Foreign Application Priority Data
Sep. 18, 2019 (JP) 2019-169420

(51) Int. Cl. G06Q 10/06; G06K 9/00; G06K 9/46; G06Q 30/06

(52) U.S. Cl. CPC G06Q 10/06315; G06Q 30/0645; G06K 9/46; G06K 9/00771

(57) ABSTRACT

A parking lot evaluation apparatus for evaluating a parking lot usable as a station of a vehicle used for car sharing service including a microprocessor and a memory coupled to the microprocessor. The microprocessor and the memory are configured to perform receiving an input of a condition relating to an area, selecting a corresponding area based on the condition relating to the area, extracting a parking lot in the corresponding area to specify an attribute of the extracted parking lot based on a predetermined condition indicating the attribute of the extracted parking lot, and evaluating a suitability of the extracted parking lot in the corresponding area as the station based on the attribute of the extracted parking lot.

### CROSS-REFERENCE TO RELATED APPLICATION

This application is based upon and claims the benefit of priority from Japanese Patent Application No. 2019-169420 filed on Sep. 18, 2019, the content of which is incorporated herein by reference.

### BACKGROUND OF THE INVENTION

### Field of the Invention

This invention relates to a parking lot evaluation apparatus and a parking lot evaluation method for evaluating a parking lot usable as a station of a vehicle used for a car sharing service.

### Description of the Related Art

Recently, a vehicle rental service in which a vehicle is rented unmanned by using an IC card or the like registered in advance and a user is charged in accordance with the use time and the use distance of the vehicle when the vehicle is returned becomes widespread (for example, disclosed in Japanese Patent Laid-Open No. 2004-178385). In such a vehicle rental service, since the number of users increases when the rental location and the return location of the rented vehicle are located in a highly convenient location, the location of the station is important. However, it is difficult to judge the convenience, and a business entity providing the vehicle rental service requires a lot of time and labor to select a parking lot suitable for the station of the vehicle to be rented.

### SUMMARY OF THE INVENTION

An aspect of the present invention is a parking lot evaluation apparatus for evaluating a parking lot usable as a station of a vehicle used for a car sharing service including a microprocessor and a memory coupled to the microprocessor. The microprocessor and the memory are configured to perform receiving an input of a condition relating to an area, selecting a corresponding area based on the condition relating to the area, extracting a parking lot in the corresponding area to specify an attribute of the extracted parking lot based on a predetermined condition indicating the attribute of the extracted parking lot, and evaluating a suitability of the extracted parking lot in the corresponding area as the station based on the attribute of the extracted parking lot.

Another aspect of the present invention is a parking lot evaluation method for evaluating a parking lot usable as a station of a vehicle used for car sharing service. The parking lot evaluation method includes receiving an input of a condition relating to an area, selecting a corresponding area based on the condition relating to the area, extracting a parking lot in the corresponding area to specify an attribute of the extracted parking lot based on a predetermined condition indicating the attribute of the extracted parking lot and evaluating a suitability of the extracted parking lot in the corresponding area as the station based on the attribute of the extracted parking lot.

### BRIEF DESCRIPTION OF THE DRAWINGS

The objects, features, and advantages of the present invention will become clearer from the following description of embodiments in relation to the attached drawings, in which:

FIG. 1A is a schematic configuration diagrams for explaining a car sharing service according to an embodiment of the present invention;

FIG. 1B is a schematic configuration diagrams for explaining the car sharing service according to an embodiment of the present invention;

FIG. 2 is a block diagram showing a configuration of a main component of a parking lot evaluation apparatus according to an embodiment of the present invention;

FIG. 3 is a diagram schematically showing an example of evaluation of a plurality of parking lots as stations output by the parking lot evaluation apparatus shown in FIG. 2; and

FIG. 4 is a flowchart showing an example of parking lot evaluation processing executed by the parking lot evaluation apparatus shown in FIG. 2.

### DETAILED DESCRIPTION OF THE INVENTION

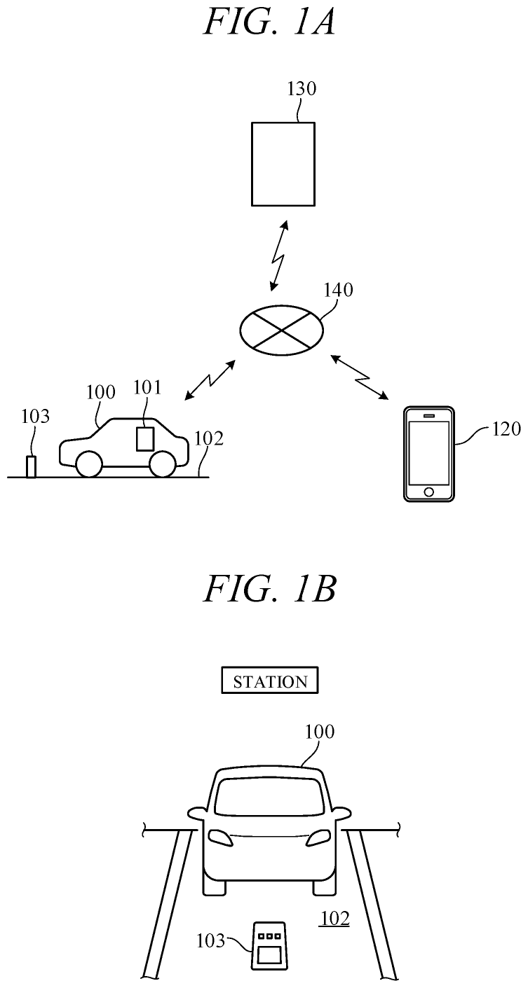

There now follows an explanation of an embodiment of the present invention with reference to FIGS. 1A to 4. The parking lot evaluation apparatus according to an embodiment of the present invention is suitably used for selecting a parking lot for use as a station of a vehicle used for a vehicle rental service. The vehicle rental service includes a service such as the car sharing service and a car rental service.

The car sharing service is a service in which unmanned vehicles (shared vehicles) are rented using an IC card or the like registered in advance, and a user is charged according to the vehicle usage time and usage distance (mileage) when the vehicle is returned. The car rental service differs from the car sharing service in that the user rent a car (shared vehicle) facing a store clerk. The parking lot evaluation apparatus according to the present embodiment can be used for selecting a station of the car rental service, but is suitable for use in selecting a station of a car sharing service.

FIGS. 1A and 1B are schematic configuration diagrams for explaining a car sharing service according to an embodiment of the present invention. As shown in the FIG. 1A, an in-vehicle terminal 101 is mounted on a vehicle 100 owned by a business entity that conducts the car sharing business and used in the car sharing business. The in-vehicle terminal 101 includes, for example, an in-vehicle navigation apparatus, and can communicate with a server apparatus 130, which will be described later, via a communication network 140.

The in-vehicle terminal 101 includes a card reader (not shown) that reads user information from an authentication card owned by the user. As the authentication card, for example, a driver's license (IC card license) in which an integrated circuit (IC) storing personal information of the user is incorporated is used. The card reader is provided, for example, below the rear window of the vehicle 100 so that the authentication card approached from the outside of the vehicle can be recognized.

A vehicle 100 used for the car sharing service uses a section (a vehicle compartment) of an unmanned parking lot having a plurality of vehicle compartments as a station 102. Herein, the vehicle used for the car sharing service sometimes called “car sharing vehicle”. The station 102 is a location where the vehicle 100 is rented and returned, and when the user uses the vehicle 100, for example, the same station 102 is the rented and returned location of the vehicle 100. As shown in the FIG. 1B, in order to clearly indicate that the station 102 is a vehicle compartment for car sharing service, a parking lot signboard 103, a flag (not shown), and the like are disposed in the station 102.

A user who uses the car sharing service is a person who has registered in advance information necessary for a business entity that conducts a car sharing business. In the present embodiment, a user using the car sharing service has a user terminal 120 operated by the user, and the user terminal 120 is configured by a portable wireless terminal typified by a personal computer or a smart phone. The user terminal 120 can communicate with the server apparatus 130 via the communication network 140, and the user enters user information through the user terminal 120 to register as a member, and then the car sharing service becomes available. The user makes a reservation and the like of the vehicle 100 via the user terminal 120.

The server apparatus 130 is provided in the business entity that conducts the car sharing business, and a part of the server apparatus 130 can be configured by using virtual server functions on cloud computing. In the car sharing service, reservation management by the user, use management of the vehicle 100, and the like are performed using the server apparatus 130. For example, the server apparatus 130 receives an application for use of the vehicle 100 input by the user via the user terminal 120. More specifically, the server apparatus 130 acquires vehicle reservation information input by the user via the user terminal 120. The reservable vehicle 100 satisfying the condition of the vehicle reservation information input by the user, such as the date and time of use of the vehicle 100, is informed to the user terminal 120. When the vehicle 100 to be reserved is selected or approved, the server apparatus 130 determines the vehicle reservation. The server apparatus 130 also creates current and future usage plans and maintenance plans for each vehicle 100 and manages the usage plan of each vehicle 100.

At the time of starting the use of the car sharing service, when the user brings the IC card (authentication card) registered in advance close to the card reader mounted on the vehicle 100 (in-vehicle terminal 101), the card reader authenticates the IC card (authentication card). The in-vehicle terminal 101 transmits the user information read from the IC card by the card reader to the server apparatus 130. The server apparatus 130 determines whether or not there is vehicle reservation information or the like corresponding to the received user information, and if there is corresponding vehicle reservation information or the like, transmits an unlocking command to the vehicle 100 (in-vehicle terminal 101). As a result, the vehicle 100 becomes available, and the user goes for a drive or the like using the available vehicle 100.

Incidentally, it is desirable that the station 102 of the vehicle 100 used for the car sharing service provided as described above is provided in a highly convenient area such as a vicinity of a train station or a dense area of a house. However, in such an area, it is difficult to secure the station 102 because the number of vacant parking lots is small. In the past, therefore, business entities themselves sought areas that were relatively convenient, and in such areas, they diverted part of the coin parking lot or leased part of the condominium parking lot to secure the station 102. However, even the stations 102 is in a highly convenient area, it is not desirable that the parking lot itself be in a place where it is difficult to use or be provided in a manner where it is difficult to use it.

Therefore, in the parking lot evaluation apparatus of the present embodiment, the attribute of the parking lot usable for the station, which is within an area satisfying an input condition, is specified, and an evaluation in a case of using a parking lot as the station 102 is performed based on the specified parking lot attribute. Incidentally, the parking lot attribute is a characteristic of a parking lot that affects aptitude as a station, for example, the distance from the parking lot entrance to the station 102 (vehicle compartment), the presence or absence of night lighting, the difficulty of turnabout, etc.

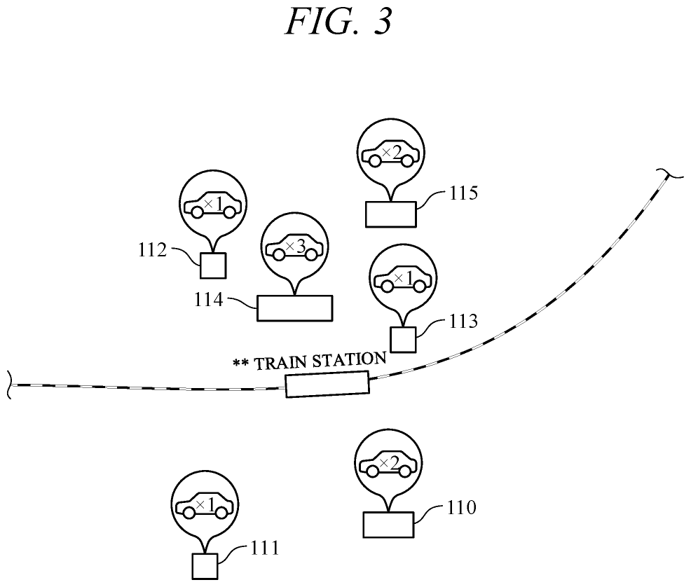

Further, in the parking lot evaluation apparatus according to the present embodiment, for example, a data distribution diagram (for example, see FIG. 3 to be described later) is created, in which the evaluation as the station 102 of each parking lot in an area satisfying an input condition can be recognized only by seeing a map of the area. As a result, the car sharing business entity can easily select a parking lot suitable for the station 102 of the vehicle 100 used for the car sharing service without taking time and labor. In order to satisfactorily realize such selection of a parking lot, the following parking lot evaluation apparatus is configured in the present embodiment.

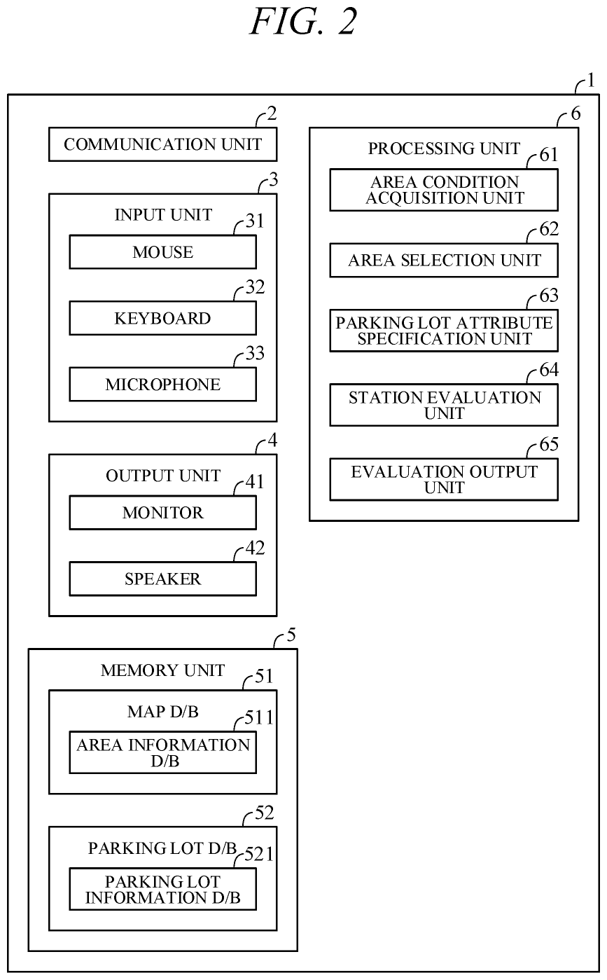

FIG. 2 is a block diagram showing a configuration of a main component of the parking lot evaluation apparatus 1 according to the present embodiment, and FIG. 3 is a diagram schematically showing an example of evaluation as stations 102 of a plurality of parking lots output by the parking lot evaluation apparatus 1 shown in FIG. 2. The parking lot evaluation apparatus 1 is provided in a business entity that performs a car sharing business, and may be provided in the server apparatus 130 described above, for example.

As shown in FIG. 2, the parking lot evaluation apparatus 1 includes a communication unit 2, an input unit 3, an output unit 4, a memory unit 5, and a processing unit 6.

The communication unit 2 is configured to be connectable to a communication network such as a wireless communication network, an Internet network, a telephone line network, or the like wirelessly or wirelessly. The input unit 3 includes a mouse 31 and a keyboard 32 that can be operated by the car sharing business entity, and a microphone 33 that can input sound. When a monitor 41 is a touch panel type, the keyboard 32 also includes a touch type button displayed on the monitor 41. Conditions relating to an area are entered, for example, via a keyboard 32.

The output unit 4 includes the monitor 41 capable of displaying an image, a speaker 42 capable of outputting sound, and the like. For example, the data distribution diagram shown in FIG. 3 and the like are displayed on the monitor 41. That is, evaluation as a station of the parking lot in the area is displayed with map information on the monitor 41.

The memory unit 5 has a volatile or nonvolatile memory (not shown). The memory unit 5 can also be configured using a virtual memory function of the clouding service. In the memory unit 5, various programs and various data to be executed by the processing unit 6 is stored. The memory unit 5 has a map database (map D/B) 51 for storing the map information and a parking lot database (parking lot D/B) 52 for storing a parking lot information, as a functional configuration of the memory. The map database 51 and the parking lot database 52 are referred to when the processing unit 6 executes the parking lot evaluation process.

The map database 51 includes an area information database (area information D/B) 511 for storing detailed data for each area. The area referred to herein includes, for example, a state (e.g., California), a city (e.g., Los Angeles, San Francisco), a street, and the like. That is, in the area information database, detailed data is stored for each state, for each city, or for each street.

The area information database 511 stores, for example, data on population such as population by age and gender, total population and number of households in each area, data on housing such as percentage of detached houses and apartment buildings, data on vehicles such as ownership rate of vehicles and driver's licenses, data on parking lots such as parking lots of public facilities, metered parking lots, and private parking lots, data on various public facilities such as presence/absence of entrances of train stations and expressways, and data on working such as number of business establishments.

The above-described data is an example of data stored in the area information database, and the data stored in the area information database is not limited to these. These data are also appropriately configured to be updatable, for example, via a communication network.

The parking lot database 52 has a parking lot information database (parking lot information D/B) 521 for storing detailed data for each parking lot. The parking lot information database 521 stores, for example, data relating to the distance from the train station, data relating to the number of vehicle compartments used as stations in the parking lot, data relating to the name and the number of stations of the car sharing business entity that uses the vehicle compartment as a station, data relating to the type of line that partitions each vehicle compartment of the parking lot, data relating to the visibility from the sidewalk, data relating to the possibility of installing an advertisement material, data relating to the distance between the entrance of the parking lot and the vehicle compartment, data relating to the difficulty of taking the vehicle into and out of the vehicle compartment, data relating to the form of the parking lot, data relating to the presence or absence of night lighting, data relating to the installation of the monitoring camera, and the like.

The data described above is an example of data stored in the parking lot database, and the data stored in the parking lot database is not limited thereto. These data are also appropriately configured to be updatable, for example, via a communication network.

The processing unit 6 includes a microprocessor (not shown). The processing unit 6 executes a predetermined process based on a signal input via the input unit 3, a signal received from the outside of the parking lot evaluation apparatus 1 via the communication unit 2, and various programs and various data stored in the memory unit 5 to output a control signal to the output unit 4 and the memory unit 5. The processing unit 6 updates the various data stored in the map database 51 and the parking lot database 52. For example, the processing unit 6 updates various data stored in the parking lot database 52 with information acquired via the communication network by the communication unit 2.

In addition, the processing unit 6 includes an area condition acquisition unit 61, an area selection unit 62, a parking lot attribute specification unit 63, a station evaluation unit 64, and an evaluation output unit 65 as functional configurations of the processor.

The area condition acquisition unit 61 receives an input of a condition relating to an area. For example, the area condition acquisition unit 61 acquires the condition relating to an area input via the input unit 3. The condition relating to an area includes, for example, a condition relating to population, housing, a vehicle, a parking lot, various public facilities, working, etc.

The condition related to population includes, for example, total population, population by age and gender, number of households, and the like. The condition relating to housing includes, for example, a ratio of detached houses, a ratio of apartment buildings, a ratio of sale and rent in apartment buildings, and the like. The condition relating to a vehicle includes the ownership rate of vehicles, the ownership rate of driver's licenses, etc. in each household. The condition related to the parking lot includes presence or absence of a parking lot of public facilities and metered parking lots, the number of vehicle compartments in parking lots of the public facilities and the metered parking lots, presence or absence of a parking lot in each house, and the like. The condition relating to various public facilities includes a location and presence of entrances and exits of train stations and expressways. The condition for working includes the number of retail dealers, business establishments, and the like.

The area condition acquisition unit 61 is configured such that a user (in this case, a car sharing business entity) inputs a condition via the input unit 3 for each of the above-described items (population, house, vehicle, various public facilities of parking lot, work, etc.) set in advance. Note that the above-described condition is an example of a condition input by the user, and the condition input by the user is not limited to this.

The area selection unit 62 selects an area based on the condition relating to an area acquired by the area condition acquisition unit 61. For example, the area selection unit 62 refers to the map database 51 stored in the memory unit 5 to select an area corresponding to the condition relating to an area acquired by the area condition acquisition unit 61. The area selection unit 62 is configured to select an area based on a city in principle, and to enlarge or reduce the range of the area by arbitrary selection by a user (in this case, a car sharing business entity).

For example, when the condition acquired by the area condition acquisition unit 61 via the input unit 3 is that the population is xx or more, the population ratio in the twenties is xx % or more, the population ratio in the thirties is xx % or more, the ownership ratio of driver's licenses is xx % or more, the ownership ratio of vehicles is xx % or less, and the ratio of apartment buildings is xx % or more, the area selection unit 62 refers to the map database 51 to select an area corresponding to the condition.

The parking lot attribute specification unit 63 extracts a parking lot in the area selected by the area selection unit 62, and, based on a plurality of conditions indicating the attributes of the parking lot, specifies the attributes of the extracted parking lot. The conditions indicating the attributes of the parking lot includes the number of stations of self-owned car sharing vehicles in the parking lot, the number of stations of other owned car sharing vehicles in the parking lot, the number of stations of other owned car sharing vehicles within a predetermined range (predetermined distance), the type of line that partitions each vehicle compartment of the parking lot, visibility from the sidewalk, whether the advertisement material can be placed, the distance between the vehicle compartment and the entrance of the parking lot, the ease of taking the vehicle into and out of the vehicle compartment, the form of the parking lot, the presence or absence of night lighting, and the presence or absence of a monitoring camera.

Specifically, the conditions indicating attributes of a parking lot, how many self-owned car sharing vehicles there are in the parking lot, how many other owned car sharing vehicles there are in the parking lot, how many other owned car sharing vehicles there are in the area, what type of line that partitions each vehicle compartment of the parking lot (e.g., single line, double line, U-shaped line) is, how the parking lot is seen from the sidewalk, whether the advertisement material such as a flag and a sign can be placed, how much the distance between the vehicle compartment and the parking lot entrance is, whether the vehicle can be easily taken into and out of the vehicle compartment, what the provision form of the parking lot is (e.g., monthly parking lot or coin parking lot), whether there is night lighting, whether there is a monitoring camera or not.

The parking lot attribute specification unit 63 specifies the attribute of the parking lot while referencing to the memory unit 5 or acquiring information through a communication network with respect to the above-described conditions. The above-mentioned condition is an example of condition for specifying the attribute of the parking lot, and the attribute of the parking lot specified by the parking lot attribute specification unit 63 is not limited to this.

The station evaluation unit 64 evaluates the suitability of the parking lot in the area as the station 102 based on the attribute of the parking lot specified by the parking lot attribute specification unit 63. For example, the station evaluation unit 64 performs evaluation of the parking lot when the parking lot is used as a station based on the visibility of the parking lot, the number of users of car sharing in the area, and the ease of use of the parking lot.

For example, in providing car sharing service, it is very important to recognize that there is a vehicle 100 to be used for the car sharing. Therefore, the closer the distance between the entrance of the parking lot and the vehicle compartment, the higher the visibility of the vehicle 100 (station 102) used for car sharing, and therefore, the station evaluation unit 64 increases the evaluation as the distance between the entrance of the parking lot and the decreases. In addition, since the visibility of the vehicle 100 (station 102) becomes higher when it is easy to see from the sidewalk, the station evaluation unit 64 makes the evaluation higher as it is easy to see from the sidewalk. In addition, since it is possible to appeal if sales promotion items such as flags and signs can be placed, the station evaluation unit 64 makes the evaluation higher if the sales promotion items can be placed. In addition, since the visibility at night is improved when there is night lighting, the station evaluation unit 64 makes the evaluation higher if there is night lighting. Since a metered parking lot has higher visibility than the monthly parking lot, the station evaluation unit 64 makes the evaluation higher if the parking lot is coin parking lot.

Further, for example, in the provision of car sharing service, the number of operators providing the car sharing business in the area is a very important factor because the presence of a vehicle to be used for not only the car sharing of its own entity but also the car sharing of another entity means that there is a user who utilizes the car sharing service in the area. Therefore, the station evaluation unit 64 makes the evaluation higher as more vehicles are used for the car sharing service, including its own entity and the other entity.

In addition, for example, the ease of exiting from the vehicle compartment and the ease of parking are important factors because the user who utilizes car sharing service is considered to have relatively low skill in driving since almost all the persons do not own the vehicle. Therefore, the station evaluation unit 64 makes the evaluation higher as the degree of difficulty in taking the vehicle into and out of the vehicle compartment is lower. Further, as the width of the line for partitioning the vehicle compartment is wider, since the relatively wider the vehicle compartment is easily taken in and out to the vehicle, the wider the line for partitioning the vehicle compartment is, the station evaluation unit 64 makes the evaluation higher.

The station evaluation unit 64 scores attributes based on the above-mentioned conditions. Then, the evaluation as the station 102 of the parking lot in the area is performed based on the score.

More specifically, the station evaluation unit 64 assigns 1 point when the entrance of the parking lot is 10 m or more, 2 points when the entrance of the parking lot is 5 m or more and 9 m or less, 3 points when the entrance of the parking lot is 2 m or more and 4 m or less, and 5 points when the entrance of the parking lot is 1 m or less.

In addition, the station evaluation unit 64 assigns zero points when the parking lot cannot be seen from the sidewalk, 1 point when the parking lot enters the field of view, 3 points when the parking lot can be seen by bending the neck or the like, and 5 points when the parking lot can be seen normally.

Further, the station evaluation unit 64 assigns 1 point if nothing can be placed, 3 points if the flag can be set, and 5 points if anything can be placed, as to whether or not the sales promotion item such as a flag or a signboard can be placed.

In addition, the station evaluation unit 64, as to whether there is night illumination, imparts zero points when there is no night illumination, 1 point when a night illumination is installed within 15 m or more and 20 m, 3 points when a night illumination is installed within 6 m or more and 14 m, and 5 points when a night illumination is installed within 5 m.

The station evaluation unit 64 assigns 3 points in the case of the monthly parking lot and 5 points in the case of the metered parking lot, as to the form of the parking lot.

In addition, the station evaluation unit 64 assigns zero points when there is no self-owned car sharing vehicle, 3 points when there is one self-owned car sharing vehicle, and 5 points when there is two or more self-owned car sharing vehicles, as to whether or not the self-owned car sharing vehicle is in the parking lot.

In addition, the station evaluation unit 64 assigns 1 point if there is no other owned car sharing vehicle, 3 points if there is one other owned car sharing vehicles, and 5 points if there is two or more other owned car sharing vehicles, as to whether or not the other owned car sharing vehicle is in the parking lot.

In addition, the station evaluation unit 64, as to whether or not a car sharing vehicle of its own entity or another entity is in the parking lot, assigns 1 point if there is no car sharing vehicle, 3 points if there is one car sharing vehicle, 4 points if there is two car sharing vehicles, and 5 points if there is three or more car sharing vehicles.

The station evaluation unit 64, as to the difficulty of taking the vehicle into and out of the vehicle compartment, assigns 1 point when twice or more turnabouts are necessary, 3 points when it is possible to take the vehicle into and out with a single turnabout, 5 points when turnabout is not necessary.

In addition, the station evaluation unit 64, as to the type of line that partitions the vehicle compartment, assigns 1 point when there is no line, 3 points when the type is a single line, and 5 points when the type is a double line or a U-shaped line.

The station evaluation unit 64, assigns 5 points if there is a monitoring camera.

The station evaluation unit 64 evaluates the suitability of the parking lot in the area as a station based on the above-mentioned score. Specifically, the station evaluation unit 64 evaluates that the parking lot is “unsuitable” as a station when the total number of points is 10 or less, and evaluates that the parking lot is “somewhat unsuitable” when the total number of points is 11 or more and 20 or less. The station evaluation unit 64 evaluates that the parking lot is “somewhat suitable” when the total number of points is 21 points or more and 40 points or less, and evaluates that the parking lot is “suitable” when the total number of points is 41 points or more.

The evaluation output unit 65 generates a data distribution diagram in which the evaluation of each parking lot evaluated by the station evaluation unit 64 is output on a map. The evaluation output unit 65 displays the evaluation of each parking lot by color-coding. For example, the evaluation output unit 65 displays a parking lot evaluated as “suitable” in red, a parking lot evaluated as “somewhat suitable” in pink, a parking lot evaluated as “somewhat unsuitable” in green, and a parking lot evaluated as “unsuitable” in blue. By displaying the evaluation of the parking lot by color-coding, the evaluation of the parking lot can be recognized only by seeing the data distribution map.

In the data distribution diagram shown in FIG. 3, “×1” or “×2” which is affixed in the picture of the vehicle indicates the number of parking lots that can be used as stations. That is, the evaluation output unit 65 displays the evaluation of the parking lot and the number of usable parking lots.

For example, since the parking lot 110 shown in FIG. 3 is displayed in red, it can be seen that there are two parking lots suitable for a station. Since the parking lots 111 to 113 shown in FIG. 3 are displayed in pink, it can be seen that there is one parking lot that is somewhat suitable for a station respectively. Since the parking lot 114 shown in FIG. 3 is displayed in green, it can be seen that there are three parking lots that are somewhat unsuitable for a station. Further, since the parking lot 115 shown in FIG. 3 is displayed in blue, it can be seen that there is one parking lot unsuitable for the station.

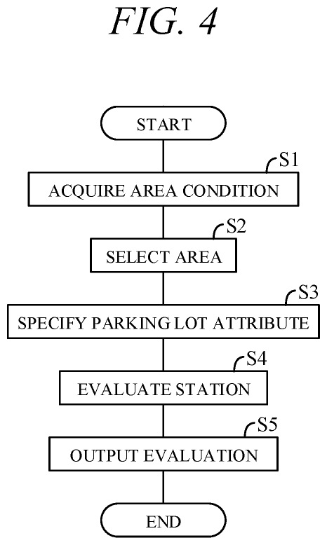

Next, parking lot evaluation processing executed by the parking lot evaluation apparatus 1 configured as described above will be described with reference to FIG. 4. FIG. 4 is a flowchart showing an example of parking lot evaluation processing executed by the parking lot evaluation apparatus 1 shown in FIG. 2. The process shown in the flowchart of FIG. 4 starts, for example, when a signal specifying the condition of the area is received from the user (in this case, the car sharing business entity) and ends by outputting an evaluation of the parking lot.

First, in step S1, by the processing in the area condition acquisition unit 61, an input of a condition relating to an area is accepted. Next, in step S2, by the processing in the area selection unit 62, an area based on the area condition acquired by the area condition acquisition unit 61 is selected. Next, in step S3, by the processing in the parking lot attribute specification unit 63, the parking lot within the area selected by the area selection unit 62 is extracted, and the attribute of the extracted parking lot is specified based on a plurality of conditions indicating the attribute of the parking lot.

Next, in step S4, by the processing in the station evaluation unit 64, the parking lot in the area as the station 102 is evaluated based on the parking lot attribute specified by the parking lot attribute specification unit 63. Next, in step S5, by the processing in the evaluation output unit 65, the evaluation as a station of each parking lot evaluated by the station evaluation unit 64 is output. The evaluation output unit 65 generates a data distribution map in which the evaluation of each parking lot evaluated by the station evaluation unit 64 is output on a map.

The present embodiment can achieve advantages and effects such as the following.

(1) The parking lot evaluation apparatus 1 evaluates the parking lots 110 to 115 usable as the station 102 of the vehicle 100 used for the car sharing service. The parking lot evaluation apparatus 1 includes: an area condition acquisition unit 61 that receives an input of a condition relating to an area; an area selection unit 62 that selects a corresponding area based on the condition relating to an area acquired by the area condition acquisition unit 61; a parking lot attribute specification unit 63 that extracts parking lots 110 to 115 in the area selected by the area selection unit 62 to specify attributes of the extracted parking lots 110 to 115 based on predetermined conditions indicating attributes of the parking lots 110 to 115; and a station evaluation unit 64 that evaluates the suitability of the parking lots 110 to 115 in the selected area as the station 102 based on attributes of the parking lots 110 to 115 specified by the parking lot attribute specification unit 63.

Owing to this configuration, it is possible to easily select the parking lots 110-115 suitable for the station 102 of the vehicle 100 to be used for the car sharing service.

(2) The predetermined condition indicating the attribute of the parking lot includes the presence or absence of a station of a vehicle used for another car sharing service within the predetermined range. In providing the car sharing service, the presence of a vehicle used for car sharing service provided by another company means that the presence of a user who uses the car sharing service, and therefore, by adding the presence or absence of the station to the condition, it is possible to more appropriately evaluate the parking lots 110 to 115 in the case where each parking lot is used as the station 102.

(3) The condition relating to the area includes the ownership rate of the vehicle in the area. In providing the car sharing service, the ownership rate of the vehicle is considered to be inversely proportional to the number of users who use the car sharing service, and therefore, by narrowing down the area by the ownership rate of the vehicle, it is possible to more appropriately evaluate the case where the parking lots 110 to 115 are used as the station 102.

(4) The predetermined condition indicating the attribute of the parking lot includes the presence or absence of a camera for imaging the parking lots 110 to 115. In providing the car sharing service, the presence or absence of monitoring cameras that take pictures of parking lots 110-115 is a very important factor since the car sharing service can be used safely. By adding such an element to the predetermined condition indicating the attribute of the parking lot, it is possible to more appropriately evaluate the parking lots 110 to 115 in the case where each parking lot is used as the station 102.

(5) A parking lot evaluation method is a method for evaluating a parking lot usable for a station of a vehicle used for car sharing. In the parking lot evaluation method, the area condition acquisition unit 61 receives an input of a condition relating to an area. The area selection unit 62 selects a corresponding area based on the acquired condition relating to the area. The parking lot attribute specification unit 63 extracts a parking lot in the selected area and specifies an attribute of the extracted parking lot based on a predetermined condition indicating the attribute of the parking lot. The station evaluation unit 64 performs evaluation as the stations 102 of the parking lots 110 to 115 in the based on the identified parking lot attributes.

Owing to this configuration, it is possible to easily select the parking lots 110-115 suitable for the station 102 of the vehicle 100 to be used for the car sharing service.

In the above embodiment, the parking lot evaluation apparatus 1 includes the area condition acquisition unit 61, the area selection unit 62, the parking lot attribute specification unit 63, the station evaluation unit 64, and the evaluation output unit 65, but the present invention is not limited thereto. The parking lot evaluation apparatus may be configured to include only an area condition acquisition unit 61, an area selection unit 62, a parking lot attribute specification unit 63, and a station evaluation unit 64.

Similarly, in the above embodiment, as the parking lot evaluation method, in step S5, the evaluation of each parking lot evaluated by the station evaluation unit 64 is output by the processing in the evaluation output unit 65, but the parking lot evaluation method may not include this step.

In the above embodiment, the present invention has been described using the number of stations of self-owned car sharing vehicles in the parking lot, the number of stations of other owned car sharing vehicles in the parking lot, the number of stations of other owned car sharing vehicles within the predetermined range, the type to line that partitions each vehicle compartment of the parking lot, visibility from the sidewalk, whether the advertisement material can be placed, the distance between the vehicle compartment and the entrance of the parking lot, the ease of taking the vehicle into and out of the vehicle compartment, the form of the parking lot, the presence or absence of night lighting, and the presence or absence of a monitoring camera as the condition indicating the attributes of the parking lot, but the condition not limited thereto. These conditions are merely an example, and the condition indicating the attributes of the parking lot may include other conditions.

According to the present invention, it is possible to easily select a parking lot suitable for a station of a vehicle used for a vehicle rental service.

Above, while the present invention has been described with reference to the preferred embodiments thereof, it will be understood, by those skilled in the art, that various changes and modifications may be made thereto without departing from the scope of the appended claims.

What is claimed is:

1. A parking lot evaluation apparatus for evaluating a parking lot usable as a station of a vehicle used for car sharing service, comprising:
a microprocessor and a memory coupled to the microprocessor, wherein
the microprocessor and the memory are configured to perform
receiving an input of a condition relating to an area;
selecting a corresponding area based on the condition relating to the area;
extracting a parking lot in the corresponding area to specify an attribute of the extracted parking lot based on a predetermined condition indicating the attribute of the extracted parking lot; and
evaluating a suitability of the extracted parking lot in the corresponding area as the station based on the attribute of the extracted parking lot.

2. The parking lot evaluation apparatus according to claim 1, wherein
the predetermined condition includes a presence or absence of a station of a vehicle used for another car sharing service within a predetermined distance.

3. The parking lot evaluation apparatus according to claim 1, wherein
the condition relating to the area includes an ownership rate of the vehicle in the area.

4. The parking lot evaluation apparatus according to claim 1, wherein
the predetermined condition includes a presence or absence of a camera for imaging the parking lot.

5. The parking lot evaluation apparatus according to claim 1, wherein
the predetermined condition includes a distance between a compartment for parking the vehicle in the parking lot and an entrance of the parking lot.

6. The parking lot evaluation apparatus according to claim 1, wherein
the predetermined condition includes a data relating to a difficulty of taking the vehicle into and out of a compartment of the parking lot.

7. The parking lot evaluation apparatus according to claim 1, wherein
the microprocessor is configured to further perform
displaying a data distribution diagram in which an evaluation of the parking lot in the area evaluated in the evaluating is output on a map on a monitor.

8. A parking lot evaluation method for evaluating a parking lot usable as a station of a vehicle used for car sharing service, including:
receiving an input of a condition relating to an area;
selecting a corresponding area based on the condition relating to the area;
extracting a parking lot in the corresponding area to specify an attribute of the extracted parking lot based on a predetermined condition indicating the attribute of the extracted parking lot; and
evaluating a suitability of the extracted parking lot in the corresponding area as the station based on the attribute of the extracted parking lot.
